(19) United States
(12) Patent Application Publication
(10) Pub. No.: US 2013/0301561 A1
(43) Pub. Date: Nov. 14, 2013

(54) System and Method for Antenna Port Association

(71) Applicant: FUTUREWEI TECHNOLOGIES, INC., Plano, TX (US)

(72) Inventors: Philippe Sartori, Algonquin, IL (US); Jianghua Liu, Beijing (CN); Anthony C.K. Soong, Plano, TX (US)

(73) Assignee: FutureWei Technologies, Inc., Plano, TX (US)

(21) Appl. No.: 13/888,784

(22) Filed: May 7, 2013

Related U.S. Application Data
(60) Provisional application No. 61/644,203, filed on May 8, 2012.

(51) Int. Cl. H04W 72/04

(52) U.S. Cl. CPC H04W 72/04
USPC 370/329

(57) ABSTRACT

In one embodiment, a method for antenna port association includes determining a permutation index in accordance with a user equipment (UE) specific configuration parameter of a UE and determining a mapping of a first plurality of physical resource elements to a second plurality of antenna ports in accordance with the permutation index. The method also includes receiving, by the UE, data in a first antenna port of the second plurality of antenna ports in accordance with the mapping.

This application claims the benefit of U.S. Provisional Application Ser. No. 61/644,203 filed on May 8, 2012, and entitled “System and Method for Implicit Antenna Port Association for a Control Channel,” which application is incorporated herein by reference.

### TECHNICAL FIELD

The present invention relates to a system and method for wireless communications, and, in particular, to a system and method for antenna port association.

### BACKGROUND

Wireless telephony systems traditionally have been deployed using the concept of a cell, with one base station (also known as a base transceiver station (BTS), Node B (NB), enhanced NB (eNB), access point) covering a given geographic area. The base station sends information to one or more user terminals, also known as user equipments (UEs).

In the Third Generation Partnership Project (3GPP) Long Term Evolution (LTE) Release-10 technical standards, transmissions from the base station to UEs include both data channels and control channels. LTE is a standard for wireless communication of high speed data for mobile phones and data terminals. Based on Global System for Mobile Communications (GSM) Enhanced Data Rates for GSM Evolution (EDGE) and Universal Mobile Telecommunications System (UMTS) High Speed Packet Access (HSPA) network technologies, LTE increases the capacity and speed of a network using a different radio interface along with core network improvements.

### SUMMARY

An embodiment method includes determining a permutation index in accordance with a user equipment (UE) specific configuration parameter of a UE and determining a mapping of a first plurality of physical resource elements to a second plurality of antenna ports in accordance with the permutation index. The method also includes receiving, by the UE, data in a first antenna port of the second plurality of antenna ports in accordance with the mapping.

Another embodiment method includes determining a mapping of a first plurality of physical resource elements to a second plurality of antenna ports of a user equipment (UE) and determining an antenna port message including a permutation index in accordance with the mapping. The method also includes transmitting, by a base station to the UE, the antenna port message and transmitting, by the base station, data to a first antenna port of the second plurality of antenna ports of the UE.

An embodiment user equipment (UE) includes a processor and a computer readable storage medium storing programming for execution by the processor. The programming includes instructions to determine a permutation index in accordance a UE specific configuration parameter of the UE and determine a mapping of a first plurality of physical resource elements to a second plurality of antenna ports in accordance with the permutation index. The programming also includes instructions to receive, by the UE from a base station, data in a first antenna port of the second plurality of antenna ports in accordance with the mapping.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an embodiment system for antenna port association;

FIG. 2 illustrates a subframe structure;

FIG. 3 illustrates another subframe structure;

FIG. 4 illustrates an additional subframe structure;

FIG. 5 illustrates yet another subframe structure;

FIG. 6 illustrates an antenna port mapping;

FIG. 7 illustrates another antenna port mapping;

FIG. 8 illustrates an additional antenna port mapping;

FIG. 9 illustrates another antenna port mapping;

FIG. 10 illustrates yet another antenna port mapping;

FIG. 11 illustrates an embodiment method for antenna port association;

FIG. 12 illustrates another embodiment method for antenna port association; and

FIG. 13 illustrates a block diagram of an embodiment of a general-purpose computer system.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

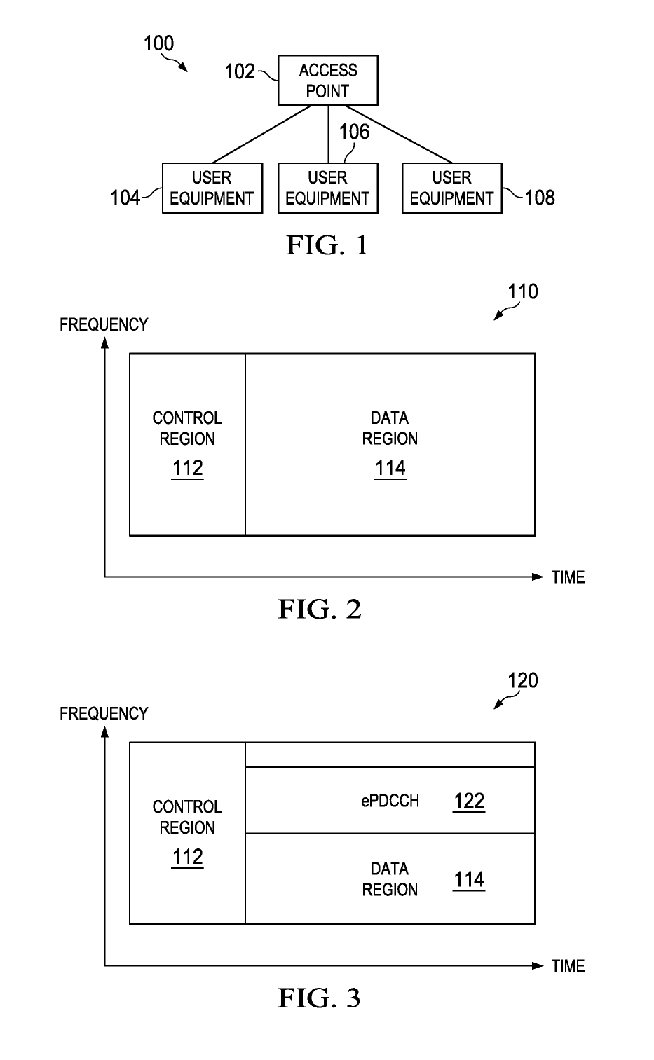

FIG. 1 illustrates system 100 for antenna port association. System 100 includes base station 102, which is coupled to user equipment (UE) 104, UE 106, and UE 108. Although three UEs are pictured in system 100, more or fewer UEs may be coupled to a single base station.

A control channel used in LTE is the physical downlink control channel (PDCCH). The PDCCH is located in the first several symbols of a subframe. For example, the PDCCH may be in one or more of the first four symbols of the subframes. The symbols containing the PDCCH may be referred to as the control domain or control region. FIG. 2 illustrates subframe structure 110, which contains control region 112. Control region contains the PDCCH. Data region 114, which may be referred to as the data domain, follows the control region. Data region 114 contains symbols for data transmission. Also, control region 112 may contain other channels, such as the physical hybrid indicator channel (PHICH), which is used to transmit an acknowledge character (ACK) or a negative acknowledge character (NACK) in response to uplink data transmissions. Additionally, the physical control format indicator channel (PCFICH), which indicates the number of symbols of control region 112, may be contained in control region 112. Data region 114 may contain one or more physical downlink shared channel (PDSCH) for UE specific data transmission.

Control region 112 contains one or more control channel elements (CCEs), which are composed of resource elements (REs). A mapping procedure assigns the REs to a time location and a frequency location within control region 112. A CCE may use non-contiguous resources to exploit frequency diversity. In an example, a control region assignment may have an aggregation level of one, two, four, or eight consecutive CCEs. A UE may use search space rules to identify possible CCEs that contain resource assignments. The search space rules, which may have provisions for a common search space, provide an upper bound in complexity.

Another control channel in LTE is the enhanced PDCCH (ePDCCH). Like the PDCCH, the ePDCCH transmits both uplink grants and downlink assignments. However, unlike the PDCCH, the ePDCCH uses a UE specific demodulation reference signal (DMRS).

The ePDCCH may have an extended search space, which may include a set of enhanced CCEs (eCCEs), and may be defined in terms of eCCEs or Resource Blocks (RBs). In an example, one RB contains four eCCEs. Unlink the PDCCH search space, the eCCEs or RBs not used for ePDCCH transmission may be used for other transmissions, such as for other ePDDCHes, PDSCHes, or other channels. Additionally, the size of eCCEs may vary on a subframe by subframe basis, depending on the amount of overhead, such as the number of symbols used for control region 112, the absence or presence of a common reference symbol (CRS), or the amount of channel state information reference signals (CSI-RS).

Also, the ePDCCH may have two types of search spaces, a UE specific search space, and a common search space (CSS). The UE specific ePDCCH search space is specific to one UE or a group of UEs. Additionally, the UE specific ePDCCH search space may be indicated to the UE by high layer signaling, such as radio resource control (RRC) signaling, or dynamic signaling such as PDCCH signaling or ePDCCH signaling. Alternatively, the UE specific ePDCCH search space may be based on a fixed location or a pre-defined calculation. All UEs may process the ePDCCH CSS, which may be used to transmit resource assignments or other signaling information.

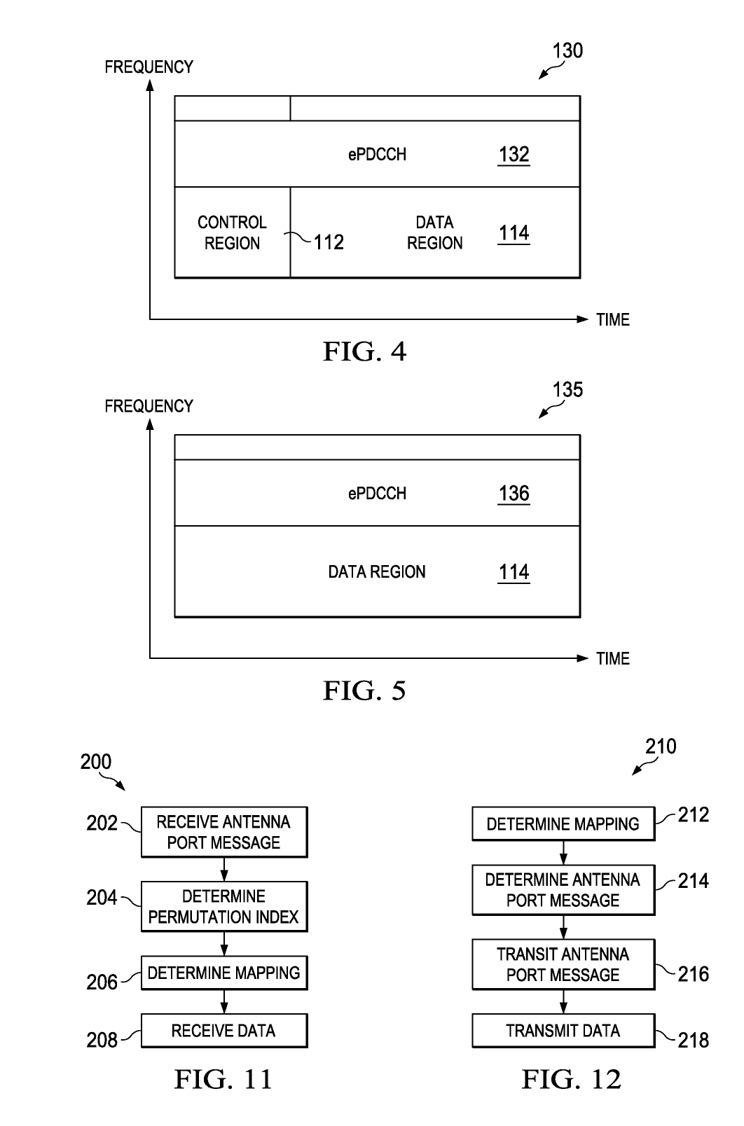

The ePDCCH may be transmitted in only data region 114, or in both data region 114 and legacy control region 112. FIG. 3 illustrates subframe structure 120, where ePDCCH 122 is transmitted only in data region 114, while FIG. 4 illustrates subframe structure 130, where ePDCCH 132 is transmitted in both data region 114 and control region 112. Subframe structure 120 and subframe structure 130 illustrate the logical domain only, and the ePDCCH may occupy non-contiguous frequency resources. In another example, a subframe structure may not have a control region. FIG. 5 illustrates subframe structure 135, which does not have a control region. Thus ePDCCH 136 is transmitted only in data region 114.

Additional differences between the PDCCH and the ePDCCH are illustrated in table 1, below. As discussed above, the PDCCH is located in the control region, while the ePDCCH is located in the data region, and may also be located in a legacy control region. Also, channels multiplexed with the PDDCH may include other PDCCH, PCFICH, physical hybrid automatic repeat request (HARM) indicator channel PHICH, and CRS. On the other hand, channel and signal multiplexing with the ePDCCH may include other ePDCCH, PDSCH, CRS, and other reference signals, such as DMRS and CSI-RS. PDCCH modulation may be fixed quadrature phase shift keying (QPSK), while ePDCCH may be variable QPSK, 16-QAM, or 64-QAM. With PDCCH, the payload size is divided in CCEs, where each CCE has a fixed size, and one, two, four, or eight CCEs may be assigned for a PDCCH. However, an ePDCCH may define payload size in eCCEs, where each eCCE may be variable in size. The PDCCH scrambling procedure involves a one-to-one correspondence between the scrambling sequence and the CCE number and position within the CCE. Because the PDCCH scrambling procedure cannot be used on the ePDCCH, an ePDCCH scrambling procedure is needed. Also, because the ePDCCH search space is different than the PDCCH search space, which uses a hash function, a method of defining the ePDCCH search space is needed. Additionally, while the CCEs in PDCCH are a function of the control region size, number of CRSes, number of PHICHes, the cell ID, and an interleaver, the eCCE location in ePDCCH needs to be defined. A CCE has nine resource element groups (REGs), where each REG has four REs, while an eCCE is composed of REs.

TABLE 1

| Feature | PDCCH | ePDCCH |
|---|---|---|
| Location with | Control region | Data region and optionally |
| subframe | | part of the control region |
| Multiplexing | Other PDCCH, PCFICH, | Other ePDCCH, PDSCH, |
| | PHICH, CRS | CRS, other |
| | | reference signals |
| | | (DMRS, CSI-RS, etc.) |
| Modulation | Fixed, QPSK | Variable including QPSK, |
| | | 16-QAM, 64-QAM |
| Payload size | CCEs of fixed size | eCCE may be variable in |
| definition | | size |
| Scrambling | 1-to-1 correspondence | To be defined |
| | between scrambling | |
| | sequence and CCE number | |
| | and position within CCE | |
| Search space | Hash function | To be defined |
| rules | | |
| CCE location | Function of control region | To be defined |
| | size, number of CRS, | |
| | number of PHICH, cell id, | |
| | and an interleaver | |
| Decomposition | REG | REs |
| of CCE | | |

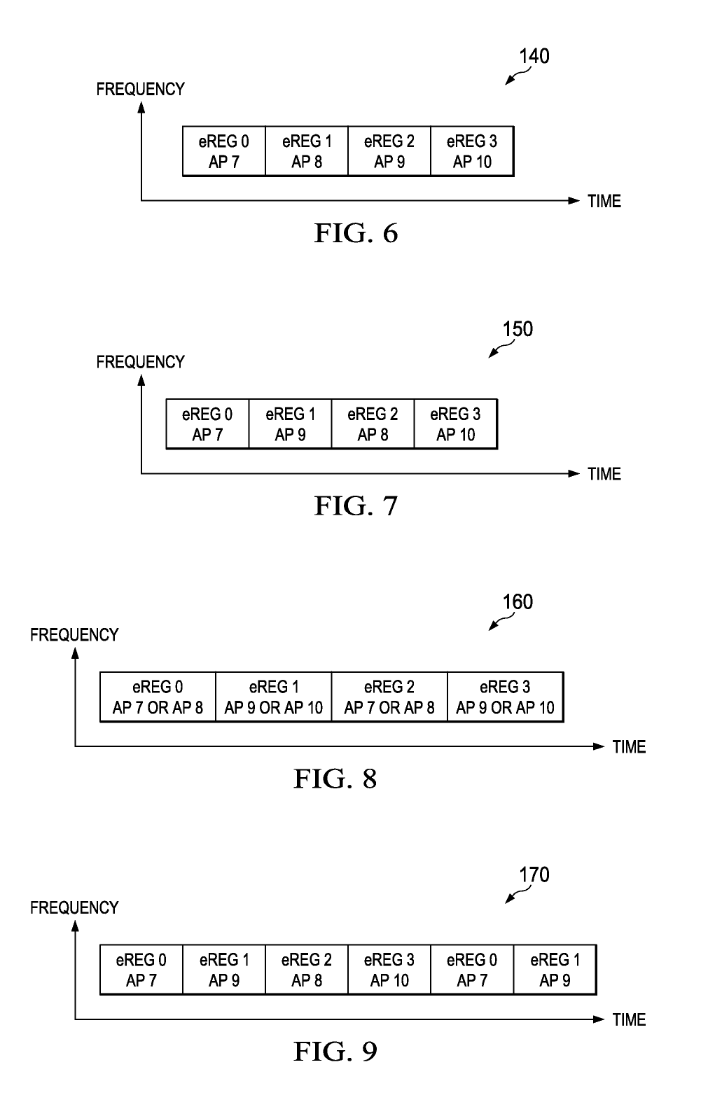

Antenna ports (APs) may be mapped to physical resource elements, such as REGs CCEs, eREGs, eCCEs, and REs. In one example, antenna ports are implicitly mapped to enhanced REGs. For example, depending on the eREG number, the antenna port is fixed. FIG. 6 illustrates mapping 140 which implicitly maps antenna ports to eREGs. For example eREG 0 is mapped to antenna port 7, eREG 1 is mapped to antenna port 8, eREG 2 is mapped to antenna port 9, and eREG 3 is mapped to antenna port 10. Mapping 140 illustrates a physical resource block (PRB) mapping, and does not necessarily represent the actual mapping of the resources. Alternatively, virtual resource blocks (VRBs) may be mapped to antenna ports.

In another example, there is an implicit antenna port association based on a UE identification number (UE ID). An example of UE ID comprises the cell RNTI. In this example, the UE is preconfigured to use the same antenna port no matter what ePDCCH candidate it attempts to demodulate. Alternatively, the UE may be configured to monitor more than one antenna port, such as two antenna ports or three antenna ports.

Alternatively, signaling may be used to indicate which permutation index to use. The UE receives a signal, such as an RRC or a dynamic signal, for example in the PDCCH or ePDCCH, to monitor one or more antenna ports. The permutation index is then used to determine which of a group of mappings to use.

In an embodiment, each physical resource element is assigned to an antenna port. The antenna port mapping to physical resource elements may be indicated by a permutation index. The permutation index is a UE specific configuration parameter which is either implicitly determined or explicitly signaled. An implicitly determined permutation index may be based on the UE ID, radio network temporary identity (RNTI), or another identifier. Alternatively, an explicitly signaled permutation index may be signaled by RRC signaling or dynamic signaling in the UE specific search space of the PDCCH, the UE specific search space of the ePDCCH, the common search space of the ePDCCH, or the common search space of the PDCCH.

Table 2 below illustrates an example correspondence between the permutation index and an antenna port to eREG mapping. The permutation index may have a similar mapping of antenna ports to other physical resource elements, such as eCCEs and REs. The permutation indices illustrated in Table 2 indicate which mapping of eREGs to antenna ports to use. The mappings are cyclical, and a permutation index of 0 has the same mapping as a permutation index of 4.

TABLE 2

| Permutation index | AP to eREG mapping |
|---|---|
| 0 | eREG0 -> AP7 |
| | eREG1 -> AP8 |
| | eREG2 -> AP9 |
| | eREG3 -> AP10 |
| 1 | eREG0 -> AP8 |
| | eREG1 -> AP9 |
| | eREG2 -> AP10 |
| | eREG3 -> AP7 |
| 2 | eREG0 -> AP9 |
| | eREG1 -> AP10 |
| | eREG2 -> AP7 |
| | eREG3 -> AP8 |
| 3 | eREG0 -> AP10 |
| | eREG1 -> AP7 |
| | eREG2 -> AP8 |
| | eREG3 -> AP9 |
| 4 | eREG0 -> AP7 |
| | eREG1 -> AP9 |
| | eREG2 -> AP8 |
| | eREG3 -> AP10 |

In another example, the correspondence between the permutation index and the antenna port to physical resource element mapping depends on the aggregation level. Table 3 illustrates an example of a correspondence between the permutation index and the antenna port to eREG mapping based on aggregation level. A similar example may illustrate a correspondence between the permutation index and the antenna port to eCCE or RE mapping. When the aggregation level is one and the permutation index is zero, mapping 140 is used. However, when the aggregation level is one and the permutation index is four, mapping 150 is used, as illustrated in FIG. 7. In mapping 150, eREG 0 is mapped to antenna port 7, eREG 1 is mapped to antenna port 9, eREG 2 is mapped to antenna port 8, and eREG 3 is mapped to antenna port 10. When the aggregation level is two, two eREGs are mapped to one antenna port. When the aggregation level is four, four eREGs are mapped to a single antenna port.

TABLE 3

| Permutation | AP to eREG mapping | | |
|---|---|---|---|
| index | Aggregation level 1 | Aggregation level 2 | Aggregation level 4 |
| 0 | eREG0 -> AP7 | (eREG0, eREG1)->AP7 | (eREG0, eREG1, eREG2, |
| | eREG1 -> AP8 | (eREG2, eREG3)->AP9 | eREG3)->AP7 |
| | eREG2 -> AP9 | | |
| | eREG3 -> AP10 | | |
| 1 | eREG0 -> AP8 | (eREG0, eREG1)->AP8 | (eREG0, eREG1, eREG2, |
| | eREG1 -> AP9 | (eREG2, eREG3)->AP10 | eREG3)->AP8 |
| | eREG2 -> AP10 | | |
| | eREG3 -> AP7 | | |
| 2 | eREG0 -> AP9 | (eREG0, eREG1)->AP7 | (eREG0, eREG1, eREG2, |
| | eREG1 -> AP10 | (eREG2, eREG3)->AP8 | eREG3)->AP9 |
| | eREG2 -> AP7 | | |
| | eREG3 -> AP8 | | |
| 3 | eREG0 -> AP10 | (eREG0, eREG1)->AP9 | (eREG0, eREG1, eREG2, |
| | eREG1 -> AP7 | (eREG2, eREG3)->AP10 | eREG3)->AP10 |
| | eREG2 -> AP8 | | |
| | eREG3 -> AP9 | | |
| 4 | eREG0 -> AP7 | (eREG0, eREG1)->AP7 | (eREG0, eREG1, eREG2, |
| | eREG1 -> AP9 | (eREG2, eREG3)->AP10 | eREG3)->AP9 |
| | eREG2 -> AP8 | | |
| | eREG3 -> AP10 | | |

In an embodiment, the permutation index is implicitly determined, for example based on the UE ID or RNTI. For example, when there are k permutation indices, the UE specific permutation index p may be determined by UE ID modulo k.

After the UE knows the predefined association between antenna ports and physical resource elements, either implicitly or explicitly, the UE may determine which antenna port is used during blind decoding. For example, if the mapping in Table 3 is used, and the permutation index zero is signaled to the UE, the UE will use antenna port 7 for channel estimation to perform blind decoding if a candidate of the search space of an aggregation level of one is mapped on eREG0. The UE will use antenna port 9 to perform blind decoding if a candidate of the search space of aggregation level two is mapped to eREG2 or eREG3. In another example, the association between antenna ports and eREGs in Table 2 is applied, and the antenna port used for channel estimation to perform blind decoding is implicitly determined by the first eREG of the first candidate in a given search space.

In an embodiment, a function maps physical resource elements to antenna ports. For each physical resource element, there may be more than one mapping function. The mapping function may be signaled either explicitly or implicitly. To reduce signaling, the functions may be grouped into one or more groups of potential mapping groups. The UE is then signaled implicitly or explicitly which mapping group to use. Also, the signaling may be simplified by signaling only an index of the group to the UE.

The signaling group the UE uses may vary over time. For example, the mapping group may be periodic, and the UE cycles through the entire set. The periodicity and the starting group may be signaled to the UE. In another example, the group is periodic, and the UE cycles through a subset of the groups. In this example, the signaling may include the periodicity, the starting group, and the subset of groups. Alternatively, one or more groups may be grouped together to form a cycling set, and the UE is signaled the periodicity, the starting group, and the cycling set. This signaling may be explicit or implicit.

In another example, the UE may randomly select the group to be used at any time from the entire set or from a subset. A random number generator may be known to both the network and the UE. The UE then is signaled the seed for the random number generator explicitly or implicitly. For example, the seed may be based on a function of the UE ID or RNTI.

The physical resource element may be an RE. The mapping may be determined by an RE located at a specific time-frequency location. When puncturing is applied, and the ePDCCH is not transmitted on the specific RE determining the antenna port, the UE may assume that the antenna port used on the entire eREG is determined by this RE. Similar mappings exist for virtual resource blocks (VRBs) as well as for PRBs.

There may be more than one antenna port associated with a given physical resource element. This may improve the channel estimation performance to perform an interference measurement. FIG. 8 illustrates mapping 160, which maps one eREG to two antenna ports. In mapping 160, eREG 0 is mapped to antenna port 7 or antenna port 8, eREG 1 is mapped to antenna port 9 or antenna port 10, eREG 2 is mapped to antenna port 7 or antenna port 8, and eREG 3 is mapped to antenna port 9 or antenna port 10. In another example, some eREGs may be assigned to one antenna port, while other eREGs are assigned to multiple antenna ports.

Four physical resource elements may be used, where one physical resource element maps to one antenna port. In another embodiment, more than four physical resource elements may be used. FIG. 9 illustrates mapping 170 with more than four physical resource elements. In mapping 170, the mapping repeats, with a permutation index of four.

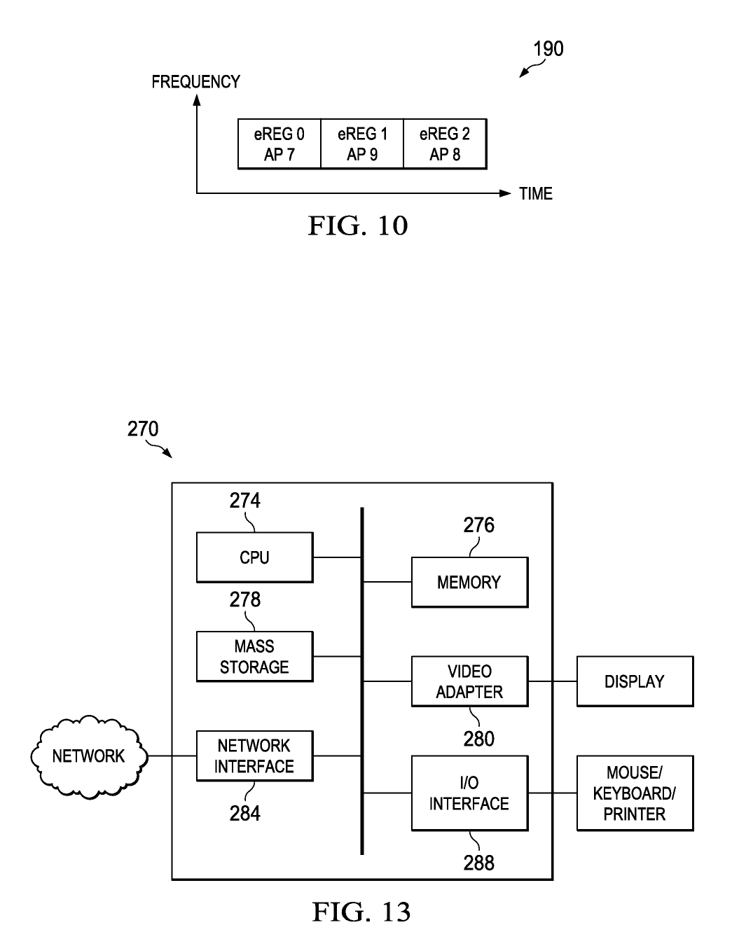

Alternatively, there may be fewer than four physical resource elements per PRB pair. The mapping may be truncated, like mapping 190 illustrated in FIG. 10. In mapping 190, three eREGs are assigned a total of three antenna ports. Such truncation rules may be used, especially for the case where the number of physical resource elements per PRB pair may vary, for example based on the subframe number. One physical resource element may also be assigned to more than one antenna ports when the number of antenna ports is larger than the number of physical resource elements in one PRB pair.

An ePDCCH candidate may occupy several physical resource elements. Each physical resource element may use a different antenna port according to the permutation index. Alternatively, the ePDCCH may be demodulated using a single antenna port. The antenna port may be determined according to a known rule. For example, the first physical resource element may define which antenna port to use.

The antenna ports in a mapping may be repeated. Table 4 illustrates an example where antenna port 7 is repeated. For a permutation index of 5, both eREG 0 and eREG 1 map to antenna port 7, while both eREG 2 and eREG 3 map to antenna port 9.

TABLE 4

| Permutation index | AP to eREG mapping |
|---|---|
| 5 | eREG0 -> AP7 |
| | eREG1 -> AP7 |
| | eREG2 -> AP9 |
| | eREG3 -> AP9 |

When the search spaces span multiple PRB pairs, the permutation index may vary from PRB pair to PRB pair. For example, PRB 0 may use the permutation index zero, while PRB 1 may use the permutation index one.

Mapping may be applied for both localization and diversity transmission of ePDCCH. For diversity transmission, when space-frequency block coding (SFBC) is used, two antenna ports are needed. When the permutation index is RRC signaled, the permutation index may be used to signal whether the ePDCCH transmission is localized or uses diversity. A first set of indices, such as 0-5, may be used for localized transmission, while a second set of indices, such as 6-8, may be used for diversity transmission. Table 5 illustrates a permutation index configuration for distributed transmission, with a permutation index of 6, and mapping one eREG to two antenna ports.

TABLE 5

| Permutation index | AP to eREG mapping |
|---|---|
| 6 | eREG0 -> AP7 + AP9 |
| | eREG1 -> AP8 + AP10 |
| | eREG2 -> AP7 + AP9 |
| | eREG3 -> AP8 + AP10 |

In an ePDCCH common search space, UE specific configurations may not be used, because all UEs demodulate the ePDCCH in the common search space. However, similar rules may apply. For example, the permutation index may be determined based on a cell ID or a virtual cell ID. Alternatively, the permutation index may be broadcasted in a master information block (MIB) or a system information block (SIB).

FIG. 11 illustrates flowchart 200 for a method of associating antenna ports. This method may be performed by a UE. Initially, in step 202, the UE may receive an antenna port message from a base station. The antenna port message port message may explicitly or implicitly indicate a permutation index. An explicit message may be an RRC signal, or it may be dynamically signaled, for example in the PDCCH or ePDCCH. For example, the permutation index may be linked to the characteristics of the PRB set of the PDCCH. When diversity transmission is used, the UE may assume that a certain permutation is used.

Next, in step 204, the permutation index is determined. The permutation index may be explicitly received in step 202. Alternatively, the permutation index may be determined implicitly, for example based on the UE ID or the RNTI. For example, the permutation index may be equal to the UE ID or RNTI modulo the number of permutation indices.

Then, the mapping of physical resource elements to antenna ports is performed using the permutation index in step 206. The physical resource element may be an eCCE, an eREG, or another physical resource element, such as an RE. The permutation index indicates to the UE which mapping of a group of mappings of physical resource elements to antenna ports to use. The groupings may by cyclical. A physical resource element may be mapped to one antenna port, or to more than one antenna port.

Finally, the UE receives data from a base station in step 208. The UE uses the mapping determined in step 206 to decide, for example which antenna port to receive data on. Also, the UE may transmit data to the base station.

FIG. 12 illustrate flowchart 210 for a method of antenna port association. This method may be performed by a base station. Initially, in step 212, the base station determines a mapping of physical resource elements to antenna ports for a UE. This may be done using pre-defined rules based on the RNTI or the type of transmission used, either diversity or frequency selective. Alternatively, the mapping may be selected in a way to maximize resource efficiency. The physical resource elements may be eCCEs, eREGs, or other physical resource elements, or virtual resource elements. The mapping may be one to one. Alternatively, one physical resource element may map to more than one port.

Next, in step 214, the base station determines an antenna port message for a UE. The antenna port message may be explicit, such as RRC signaling, or dynamically transmitted on the PDCCH or ePDCCH. The antenna port message may indicate to a UE the permutation index, which the UE will use to determine which mapping of a group of mappings to use.

Then, in step 216, the base station transmits the antenna port message to the UE.

Finally, in step 218, the base station transmits data to the UE. The UE uses the antenna port message to determine which antenna port to receive this data on.

FIG. 13 illustrates a block diagram of processing system 270 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input devices, such as a microphone, mouse, touchscreen, keypad, keyboard, and the like. Also, processing system 270 may be equipped with one or more output devices, such as a speaker, a printer, a display, and the like. The processing unit may include central processing unit (CPU) 274, memory 276, mass storage device 278, video adapter 280, and I/O interface 288 connected to a bus.

The bus may be one or more of any type of several bus architectures including a memory bus or memory controller, a peripheral bus, video bus, or the like. CPU 274 may comprise any type of electronic data processor. Memory 276 may comprise any type of system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

Mass storage device 278 may comprise any type of storage device configured to store data, programs, and other information and to make the data, programs, and other information accessible via the bus. Mass storage device 278 may comprise, for example, one or more of a solid state drive, hard disk drive, a magnetic disk drive, an optical disk drive, or the like.

Video adaptor 280 and I/O interface 288 provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface card (not pictured) may be used to provide a serial interface for a printer.

The processing unit also includes one or more network interface 284, which may comprise wired links, such as an Ethernet cable or the like, and/or wireless links to access nodes or different networks. Network interface 284 allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for antenna port association, the method comprising:
determining a permutation index in accordance with a user equipment (UE) specific configuration parameter of a UE;
determining a mapping of a first plurality of physical resource elements to a second plurality of antenna ports in accordance with the permutation index; and
receiving, by the UE, data in a first antenna port of the second plurality of antenna ports in accordance with the mapping.

2. The method of claim 1, wherein the first plurality of physical resource elements comprises a third plurality of enhanced resource element groups (eREGs).

3. The method of claim 1, wherein the first plurality of physical resource elements comprises a third plurality of enhanced control channel elements (eCCEs).

4. The method of claim 1, wherein the first plurality of physical resource elements consists of four physical resource elements.

5. The method of claim 1, wherein the first plurality of physical resource elements comprises five antenna ports.

6. The method of claim 1, wherein the first plurality of physical resource elements consists of two or three antenna ports.

7. The method of claim 1, wherein the UE specific configuration parameter is a UE identification number (UE ID) or a radio network temporary identity (RNTI).

8. The method of claim 1, further comprising receiving, by the UE, an antenna port message, wherein determining the permutation index is further in accordance with the antenna port message.

9. The method of claim 8, wherein the antenna port message is a radio resource control (RRC) signal, and a physical downlink control channel (PDCCH), or an enhanced physical downing control channel (ePDCCH).

10. The method or claim 1, wherein determining the mapping comprises:
determining a first mapping group of a third plurality of mapping groups in accordance with the permutation index; and
determining the mapping in accordance with the first mapping group.

11. The method of claim 10, wherein the third plurality of mapping groups is periodic.

12. The method of claim 11, further comprising receiving, by the UE, an antenna port message, wherein determining the permutation index is further in accordance with the antenna port message, and wherein the antenna port message comprises a periodicity of the third plurality of mapping groups and a starting group of the third plurality of mapping groups.

13. The method of claim 12, wherein the antenna port message further comprises a subset of groups of the third plurality of mapping groups.

14. The method of claim 11, wherein the third plurality of mapping groups comprises a plurality of cycling sets.

15. The method of claim 11, wherein determining the first mapping group comprises using a random number generator.

16. The method of claim 1, wherein the mapping of the first plurality of physical resource elements to the second plurality of antenna ports is a one-to-one mapping.

17. The method of claim 1, wherein determining the permutation index is performed in accordance with an aggregation level.

18. A method for antenna port association, the method comprising:
determining a mapping of a first plurality of physical resource elements to a second plurality of antenna ports of a user equipment (UE);
determining an antenna port message comprising a permutation index in accordance with the mapping;
transmitting, by a base station to the UE, the antenna port message; and
transmitting, by the base station, data to a first antenna port of the second plurality of antenna ports of the UE.

19. The method of claim 18, wherein the first plurality of physical resource elements comprises a third plurality of enhanced resource element groups (eREGs).

20. The method of claim 18, wherein the first plurality of physical resource elements comprises a third plurality of enhanced control channel elements (eCCEs).

21. A user equipment (UE) comprising:
a processor; and
a computer readable storage medium storing programming for execution by the processor, the programming including instructions to
determine a permutation index in accordance a UE specific configuration parameter of the UE,
determine a mapping of a first plurality of physical resource elements to a second plurality of antenna ports in accordance with the permutation index, and
receive, by the UE from a base station, data in a first antenna port of the second plurality of antenna ports in accordance with the mapping.
